(19) United States
(12) Patent Application Publication
(10) Pub. No.: US 2013/0202111 A1
(43) Pub. Date: Aug. 8, 2013

(54) WIRELESS SECURITY PROTOCOL

(71) Applicants: Hesham El Gamal, Dublin, OH (US); Yara Omar Abdallah, Giza (EG); Moustafa Amin Youssef, Greenbelt, MD (US)

(72) Inventors: Hesham El Gamal, Dublin, OH (US); Yara Omar Abdallah, Giza (EG); Moustafa Amin Youssef, Greenbelt, MD (US)

(73) Assignee: The Ohio State University, Columbus, OH (US)

(21) Appl. No.: 13/501,037

(22) PCT Filed: Oct. 7, 2010
(86) PCT No.: PCT/US2010/051807

§ 371 Date: Apr. 1, 2013

Related U.S. Application Data
(60) Provisional application No. 61/249,435, filed on Oct. 7, 2009.

(51) Int. Cl. H04W 12/02

(52) U.S. Cl. CPC H04W 12/02
USPC 380/270

(57) ABSTRACT

A method of encryption and decryption applied to a transmitted plaintext message in a communication network containing multiple subscriber nodes is provided. The method comprises the steps of: processing an Integrity check value (ICV); using a private key at the first subscriber node; providing a random initialization vector (W) executing a first operation on the random IV to obtain a sum IV; using the sum IV to process an encryption on the plaintext to obtain the ciphertext; transmitting the ciphertext to the second subscriber node wherein the second node receives the ciphertext; identifies the IV; utilizes the private key and the IV to process the decryption of the ciphertext to obtain the plaintext; generates a feedback message, the feedback message is then used to generate future sum IVs.

### This application claims the priority of U.S. Provisional Patent Application No. 61/249,435, filed on Oct. 7, 2009, the disclosure of which is incorporated herein in its entirety by reference.

### TECHNICAL FIELD

The present application is in the field of wireless security protocols and more particularly in the field of wireless security on 802.11 networks.

### BACKGROUND OF THE ART

It has been documented that existing 802.11 networks secured by the Wired Equivalency Privacy (WEP) protocol are vulnerable to passive attacks. This coupled with the fact that Wi-Fi networks are gaining popularity, in a wide variety of applications creates a serious problem for users concerned with the security of their data. Despite its vulnerability to several known security attacks and the availability of more robust security protocols, i.e., WPA and WPA2, the (WEP) protocol is still widely used for securing Wi-Fi networks. As of October 2008, RSA, The Security Division of EMC, reported that 48%, 38% and 24% of NYC, London and Paris Wi-Fi networks still employ the WEP protocol, respectively. This is likely due to the significant advantage that the WEP protocol enjoys, in terms of user friendliness, over competing approaches. Therefore, there exists a need to secure wireless networks without burdening users with cumbersome layers of security protocols while retaining the user-friendliness of WEP protected networks.

### SUMMARY OF THE INVENTION

This and other unmet needs of the prior art are met by a device as described in more detail below.

Conventional Wi-Fi networks that utilize a WEP protocol are susceptible to passive attacks by eavesdroppers due to the relative ease of acquiring Initialization Vectors (IV) from communicating nodes. Disclosed embodiments demonstrate a system and method for encrypting IV's and messages such that decryption is made nearly impossible should an eavesdropper fail to intercept one ACK frame from the communication stream. The encryption is based on an iterative feedback wherein randomly generated IV's are modified with a second IV's generated from a feedback loop based on the number of ACK frames and their header IVs that are received and successfully decrypted by the intended node. Thus, the IV for any frame is seeded with an IV that is distributed over all previously sent frames.

In a communication network containing multiple subscriber nodes, a method of encryption/decryption of a message includes: computing a check value; appending the check value to a plaintext; generating a random initialization vector; performing an operation on the random IV; this operation utilizing a second IV to generate a sum IV; generating a keystream utilizing a private key and the sum IV; performing an operation on the message with the keystream to generate a ciphertext; transmitting the ciphertext and the random initialization vector to a second subscriber node wherein the second subscriber node receives the ciphertext; selects the private key; utilizes the private key to process a decryption to the ciphertext and obtain the plaintext.

The step of generating a keystream utilizing the private may further include a step of performing an operation on the initialization vector to generate a modified vector which is used to generate the keystream. The operation may be an exclusive OR (XOR) operation with the initialization vector and the second initialization vector. The sum vector may be a sum of all the header initialization vectors received and successfully decrypted by the second subscriber node.

Preferably, the communication network is a wireless communication network.

Preferably, the encryption comprises steps of: providing a random initialization vector; executing a second operation for the initialization vector and the private key to obtain a key stream; and executing an exclusive OR (XOR) operation with the key stream for the plaintext attached with an integrity check value (ICV) and adding the initialization vector thereto for obtaining the ciphertext.

Preferably, the integrity check value (ICV) is produced by operating the message through an integrity check algorithm. Preferably, the integrity check algorithm processes a cyclic redundancy check 32 (CRC 32) operation.

Preferably, the second operation is completed by a wired equivalent privacy (WEP) encrypted algorithm. WEP uses the RC4 PRNG algorithm.

Preferably, the subsequent decryption comprises steps of: obtaining the initialization vector from the ciphertext; and executing an exclusive OR (XOR) operation with the key sequence for the ciphertext without the initialization vector to obtain the plaintext attached with the integrity check value (ICV).

### BRIEF DESCRIPTION OF THE DRAWINGS

A better understanding of the exemplary embodiments of the invention will be had when reference is made to the accompanying drawings, wherein identical parts are identified with identical reference numerals, and wherein:

FIG. 1 is a representation of a two-way communication in a network with a passive eavesdropper.

FIG. 2 is a conventional WEP encryption architecture.

FIG. 3 is a graph of experimental results.

FIG. 4 is a graph of experimental results.

FIG. 5 is a novel encryption/decryption architecture.

### DETAILED DESCRIPTION

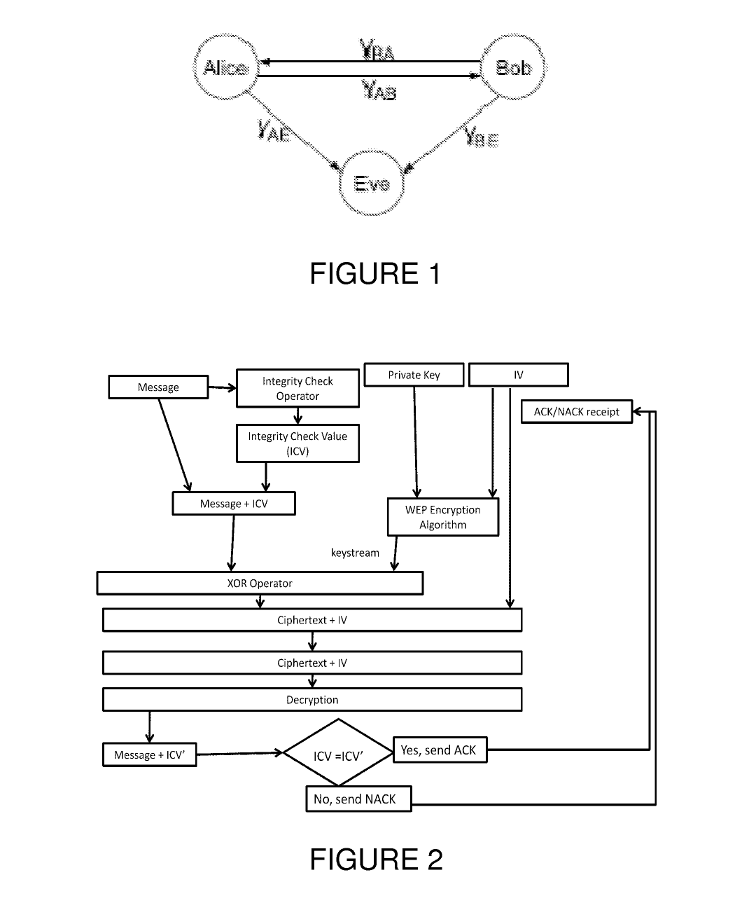

Turning to the drawings for a better understanding, FIG. 1 shows an example of a first subscriber node (Alice), sending a number of encrypted data frames to a second subscriber node (Bob) on a communication network with an eavesdropper (Eve) intercepting frames. Both nodes follow the ARQ mechanism adopted in the IEEE 802.11 standard. The network is secured by a conventional WEP protocol. An embodiment of a WEP protocol is shown in FIG. 2.

In this example of Wi-Fi network encrypted by a conventional WEP protocol, Alice and Bob are assumed to share a single 104-bit private key, Kₛ, which is used to encrypt/decrypt all n_{d} data frames sent by Alice. For the i^{th} data frame, containing a message M(i), a CRC32 checksum (used as an Integrity Check Value), i.e., ICV (M(i)), is computed and appended to the message forming the plaintext, P(i). The RC4 algorithm is then seeded with the concatenation of a pseudo-random 24-bit Initialization Vector (IV), denoted by V(i), and the private key to generate the keystream, RC4 (V (i),Kₛ). The ciphertext, C(i), is obtained by XORing the plaintext with the generated keystream. Finally, Alice sends C(i) along with the IV. More formally:

C(i)=P(i)⊕RC4(V(i),Kₛ), (1)

A→B:V(i),C(i). (2)

After recovering the IV, which was sent as plaintext in the MAC header, Bob generates the RC4 keystream, RC4 (V (i),Kₛ), and XORes it with the received ciphertext to obtain the plaintext, P″(i). The final step is to compute a checksum, ICV″, from the received message, M″(i), and compare it with the received ICV″(i). If they match, successful decryption is declared and the frame is passed to higher layers; otherwise an error is declared and the frame is dropped.

Inspection of passive WEP attacks reveals their dependence on collecting a large number of ciphertext/plaintext pairs with unique IVs which are sent as plaintext. For example, an attacker would typically need 1.5 million frames with unique IVs, before launching a combined certain attacks. Plaintext bytes could be guessed through the knowledge of the format of upper layer packets, e.g., ARP or IPv4 packets. Advanced statistical techniques can be used to recover the only unknown variable, i.e., the private key Ks, without much difficulty. In a nutshell, sending the IVs in the clear, without further encryption, along with using the same private Ks in all frames, is the main vulnerability of the WEP protocol. The proposed solution will transform the IVs into secret keys by exploiting the available ARQ mechanism in the 802.11 standard. This way, the main weakness of the WEP protocol may be circumvented while preserving the simplicity and user friendliness associated with using only one private key.

The protocol of the present application, in contradistinction to conventional protocols conceals the IVs from Eve by introducing slight modifications to the currently implemented WEP protocol in 802.11 networks. This is accomplished by introducing aspects of the ARQ mechanism into the WEP protocol. The goal is to prevent Eve from collecting the required number of IVs to launch her attack. This goal is achieved by seeding the RC4 algorithm with an IV that is distributed over all previously sent frames in a fashion that utilizes both the ARQ protocol and the independence between the channels seen by Eve and Bob.

The following notations will help to illustrate the algorithm. Let Q(i)=1 if Alice receives an ACK for an i^{th} frame (Q(i)=0 otherwise) and S(i)=1 if Bob successfully decrypts the i^{th} frame (S(i)=0 otherwise). For data encryption, the following modifications are made. The i^{th} data frame carries a new randomly-generated IV in its MAC header, denoted by Vₕ(i). However, for each data frame, the RC4 algorithm is seeded with the modulo-2 sum of all header IVs which were sent by Alice and successfully received by Bob. This sum is referred to as Vₑ(i). As opposed to the original WEP protocol, i.e., (1) and (2), in the i^{th} transmitted frame:

$$\begin{matrix}{V}_{e} ( i ) = \{ \begin{matrix}{V}_{e} ( i - 1 ) ⊕ {V}_{h} ( i - 1 ) , & if Q ( i - 1 ) = 1 ; \\ {V}_{e} ( i - 1 ) , & otherwise .\end{matrix} & ( 3 ) \\ C ( i ) = P ( i ) ⊕ RC 4 ( {V}_{e} ( i ) , {K}_{s} ) , & ( 4 ) \\ A \to B : {V}_{h} ( i ) , C ( i ) , & ( 5 )\end{matrix}$$

where Vₑ(0)=0. Bob attempts to decrypt the i^{th} received frame with Kₛ and the modulo-2 sum of all IVs previously received, referred to as V_{d}(i). If decryption fails, Bob excludes the last IV from the sum, i.e.,

$${V}_{d} ( i ) = \{ \begin{matrix}{V}_{d} ( i - 1 ) ⊕ {V}_{h} ( i - 1 ) , & if S ( i - 1 ) = 1 ; \\ {V}_{d} ( i - 1 ) , & otherwise .\end{matrix} \qquad ( 6 )$$

Again, V_{d}(0)=0. Furthermore, the history of all received ACKs by Alice is embedded in each encrypted frame. This way any mis-synchronization that could happen due to the loss of an ACK frame is avoided without any additional feedback bits.

Now, in order to launch an attack, Eve attempts to collect as many of the data frames sent by Alice as possible. Here, however, the usefulness of the collected traffic depends on Eve's ability to correctly compute Ve for each received frame. Such ability is hampered as Eve becomes completely blind upon missing a single ACKed frame. This observation motivates the use of a number of initialization frames at the beginning of each session (before any data exchange), to reduce the secrecy outage probability by adding more IVs to the encryption sum. The initialization frames contain only IVs, as plaintext, so as to reveal no information about the secret key, Ks. The experimental results, reported in the examples section, will investigate the throughput-secrecy trade-off governed by the ratio of the total size of initialization frames to the session size, in different practical settings. In summary, the IV used for encryption/decryption is the secret key shared via the underlying ARQ protocol.

Implementation details are as follows. The ARQ-WEP prototype was incorporated in the madwifi-ng driver by modifying the wlan wep and ath pci modules, in software encryption mode. The detection of acknowledgments and timeout events was established by using the Hardware Abstraction Layer (HAL) reports to the driver. In an infrastructure network architecture, the Access Point (AP) and each client store all the necessary information for data exchange. The eavesdropper maintains similar information for each client/AP session of interest. Initialization frames are implemented as (un-encrypted) association management frames with extended subtypes. To optimize performance, these frames are exchanged in bursts with the use of custom NACKs. The average initialization frame length is 42 bytes, which is negligible, as compared to a typical data frame size. The total number of initialization frames varies depending on the required secrecy level and acceptable overhead.

The modified madwifi-ng driver was deployed on laptops running the FC8 Linux distribution and D-Link wireless cards (DWL-G650). Experiments were conducted in an infra-structure IEEE 802.11g network composed of an AP and a single client (STA), with one passive eavesdropper, enabled in monitor mode.

The expected number of useful frames that Eve obtains per session, i.e., the data frames that Eve could successfully compute their encryption IVs was evaluated. For each session between Alice and Bob, the expected number of these frames can be upper bounded as E[u].

$$, \qquad ( 7 )$$

where γ′AE=1−γAE, ki is the number of initialization frames successfully received by Bob, and k is the total number of frames successfully received by Bob. As shown in (7), a slight increase of the overhead introduced by the initialization frames, results in a significant decrease in the number of frames Eve could use per session, and thus, a significant increase in the listening time needed to launch an attack. The analytical estimate was validated experimentally by generating one-way traffic between the AP (Alice) and the client node (Bob). Eve's driver was equipped with the same logic used in the protocol, i.e., the modified driver monitors all transmitted frames in the network, extracts their IVs, and sums them based on the observed ACKs/timeouts. Two experiments were launched in two different environments. In the first, Eve was observed to have better channel conditions, on the average, than Bob. While in the second, the situation was reversed and all channels suffered from relatively large erasure probabilities.

Each experiment was run at different numbers of initialization frames, compared the IVs obtained by Eve and Bob, and calculated the average number of useful frames at Eve, over 40 trials for each sample point. For both experiments, the data session size is 100,000 frames.

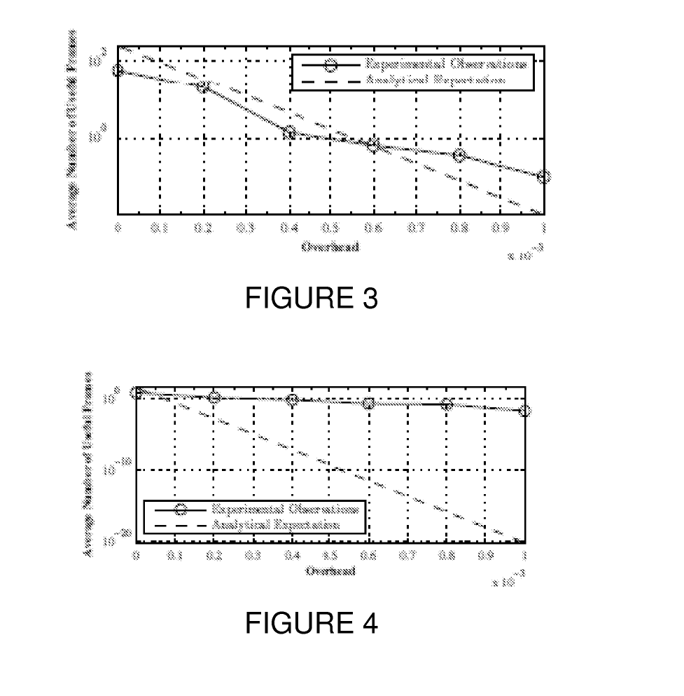

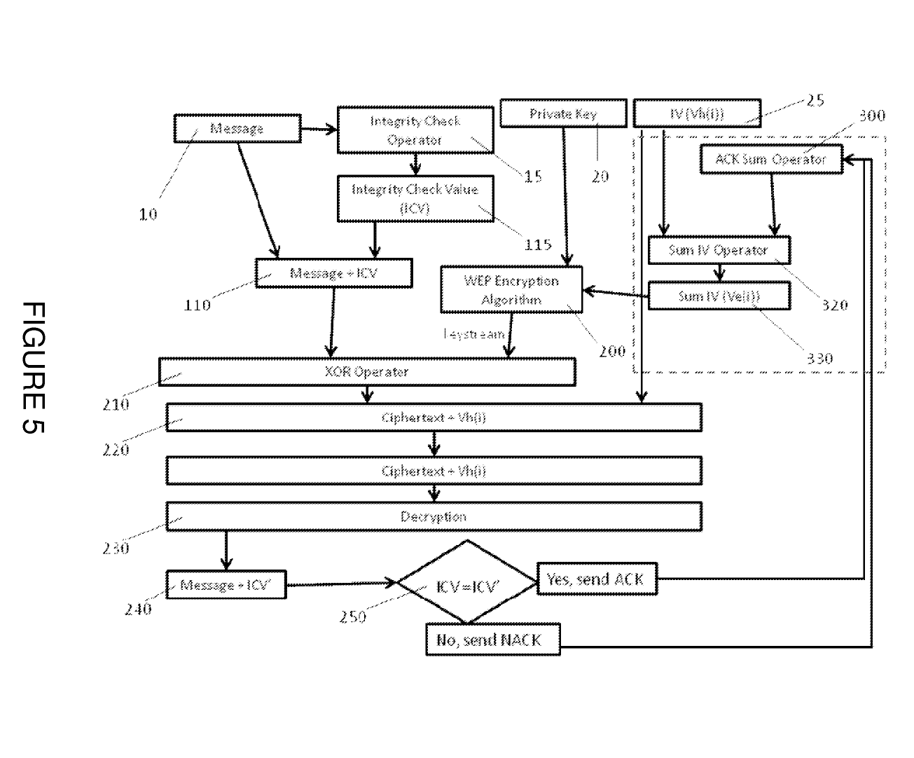

The results are reported in FIGS. 3 and 4. The disagreement between the analytical estimates and the experimental results appears to be due to the small number of samples used in the experiments. However, to compare the secrecy gain relative to the original WEP, one can use the reported results in these figures to estimate the required time for Eve to gather the required 1.5 million frames to launch an attack. Under the standard WEP operation, it was assume that Eve needs 10 minutes to gather such traffic. On the other hand, the estimated average attack time, with the proposed ARQ-WEP and no initialization overhead, is 19.35 hours and 5.23 days, for the first and second setups, respectively. An overhead of 0.001 extends the required average listening time to 1.24 years and 5.07 years, respectively. Clearly, the ARQ-WEP is able to achieve very impressive secrecy gains with only a marginal loss in throughput.

FIG. 5 shows a block diagram of an encryption/decryption method. In this embodiment a first subscriber node is transmitting a message 10 to a second subscriber node. An integrity check value 115 is computed by the integrity check operator 15 at the first subscriber end using an integrity check algorithm. In an embodiment, the integrity check value is the CRC32 checksum of the message. The ICV is then appended to the message to form a plaintext or Message+ICV 110. The message+ICV is then transmitted to an XOR operator 210.

The first subscriber node and the second subscriber node share a private key 20. The first subscriber node generates a 24-bit random IV 25, which is seeded into the Sum IV Operator 320. Additionally, an ACK sum Operator 320 compiles the header IVs of all the received ACK messages that have been received from the second subscriber node upon successful decryption of previous messages. In an embodiment, the ACK sum operator 320 creates a modulo-2 sum of all of the header IV's that were previously sent by the first subscriber node and successfully received by the second subscriber node. This sum is used with the random IV 25 in a first operation to generate a Sum IV 330. The first operation may be an XOR operation. This Sum IV 330 will be equal to the random IV 25 if there have been no previously successful decryptions performed by the second subscriber node during this communication (and correspondingly no ACK messages). The Sum IV 330 is then seeded along with the private key 20 into the WEP encryption algorithm 200 to generate a keystream. In an embodiment, the WEP encryption algorithm is a RC4 algorithm.

An XOR operation is then processed by a XOR Operator 210 to produce a ciphertext. The ciphertext and the random IV 220 are then transmitted to the second subscriber node.

Upon receipt of 220 the second subscriber node performs a decryption of the ciphertext+IV to receive a message and an Integrity Check Value ICV′ 240. The second subscriber node will utilize a second sum IV for decryption. The second sum IV will be equal to the modulo-2 sum of the previously successfully received messages, thus synchronization between the first and second subscriber nodes is preserved. If the ICV and the ICV′ match then successful decryption is declared and an ACK message is sent to the first subscriber node. This ACK message and the corresponding header IV is then used by the first subscriber node to calculate future second IV's in an iterative process. If the ICV and ICV′ do not match then decryption fails and NACK message is sent. NACK messages are not used to calculate ACK Sum IV's thus the process reverts to the unsuccessful Sum IV for resending.

In accordance with another embodiment, an encryption and decryption device for transmitting a message in a communication network containing a first subscriber node and a second subscriber node, which comprises: a private key generator mounted in the first subscriber node for producing a private key; a random IV generator at the first subscriber node for generating a random IV; a Sum IV Operator at the first subscriber node for generating a Sum IV; an encryption operator electrically connected to the private key operator for utilizing the private key to process a subsequent encryption to the message so as to obtain a ciphertext to be transmitted to a second subscriber end; a Sum IV operator at the second subscriber node for generating a second Sum IV; a decryption operator electrically connected to the second subscriber node for utilizing the private key to process a subsequent decryption to the ciphertext to obtain the message. Preferably, the communication network is a wireless communication network.

Preferably, the encryption operator comprises: a key stream operator for executing a second operation for a random initialization vector and the private key to obtain a key stream; and an exclusive OR (XOR) operator for utilizing the key stream to execute an XOR operation for the plaintext attached with an integrity check value and adding the initialization vector to obtain the ciphertext.

Preferably, the ICV is produced by executing an integrity check algorithm with the plaintext through an integrity check operator. Preferably, the integrity check algorithm processes a cyclic redundancy check 32 (CRC 32) operation. Preferably, the key sequence operator is completed by a wired equivalent privacy (WEP) encryption algorithm. WEP uses the RC4 PRNG algorithm.

Preferably, the decryption device comprises: a key stream operator for obtaining the initialization vector through the ciphertext; and an exclusive OR (XOR) operator for utilizing the key stream to execute an XOR operation for the ciphertext without the initialization vector to obtain the plaintext attached with the integrity check value.

Having shown and described an embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is claimed is:

1. An encryption and decryption method for transmitting a message in a communication network with multiple subscriber nodes, the method comprising the steps of:
generating a random initialization vector at the first subscriber node;
processing a first operation on the random initialization vector to obtain a sum initialization vector;
encrypting the message using a private key and the sum initialization vector to obtain a ciphertext to be transmitted to a second subscriber node;
transmitting the random initialization vector and the ciphertext to a second subscriber node;
wherein said second node:
receives the ciphertext and the random initialization vector; and
utilizes the private key and a second sum initialization vector to process a decryption to the ciphertext by the second subscriber node to obtain the message.

2. The method of claim 1 wherein using a private key comprises selecting a private key.

3. The method of claim 1 wherein using a private key comprises generating a private key.

4. The method of claim 1 further comprising the step of computing an Integrity Check Value (ICV) for the message prior to processing the encryption.

5. The method of claim 4 wherein the ICV is a CRC32 checksum.

6. The method of claim 1 wherein the encryption follows a protocol selected from the group consisting of: WEP protocol, WPA protocol, and WPA2 protocol.

7. The method of claim 1 wherein the encryption follows a WEP protocol and the ICV is appended to the message to create a plaintext.

8. The method of claim 7 wherein the WEP protocol is the RC4 algorithm.

9. The method of claim 8 wherein the encryption further comprises the step of generating a keystream by seeding the RC4 algorithm with the sum IV and the private key.

10. The method of claim 9 wherein the encryption further comprises the step of performing an XOR operation on the plaintext and the keystream.

11. The method of claim 1 further comprising the step of sending an ACK message from the second subscriber node if decryption is successful, and sending a NACK message if decryption is unsuccessful.

12. The method of claim 1 wherein the step of processing a first operation on the random initialization vector further comprises utilizing a second initialization vector generated from a feedback message.

13. The method of claim 12 wherein the feedback message utilizes an ARQ protocol.

14. The method of claim 13 wherein the feedback message is an ACK message sent from the second subscriber node to the first subscriber node.

15. The method of claim 14 further comprising the step of generating the second initialization vector from a stored compilation of header IVs.

16. The method of claim 15 wherein the second initialization vector is a modulo-2 sum of any previously received header IVs successfully decrypted by the second subscriber node.

17. The method of claim 14 wherein the operation comprises performing an exclusive OR operation with the random initialization vector and the second initialization vector to obtain a sum initialization vector, and wherein the sum initialization vector and the random initialization vector are identical when no feedback messages have been received by the first subscriber node.

18. An encryption and decryption method for transmitting a message in a communication network with multiple subscriber nodes, the method comprising the steps of:
receiving a transmitted ciphertext and random initialization vector at a second subscriber node, the transmission having been generated at a first subscriber node;
selecting the random IV from the transmission;
performing an operation on the random IV to obtain a second sum IV;
processing an operation on the ciphertext to obtain the message, wherein the operation further comprises generating a second IV from feedback messages and utilizing the second IV to generate the second sum IV; and
sending an ACK message if successful decryption is declared or sending a NACK message if decryption is unsuccessful.

19. An encryption and decryption device applied for transmitting a message in a communication network containing a first subscriber node and a second subscriber node, the device comprising:
a private key generator connected to the first subscriber node;
a protocol encryption algorithm operator connected to the private key generator, for generating a keystream;
an encryption operator connected to the protocol encryption operator, for generating a ciphertext;
a sum IV operator for generating sum IVs connected to the protocol encryption operator;
a random IV generator connected to the sum IV operator;
an ACK sum operator for compiling received ACK messages and generating IVs connected to the sum IV operator;
an integrity check operator connected to the encryption operator;
a decryption operator connected at the second subscriber node;
an ACK/NACK message generator for sending messages upon decryption; and
a second ACK sum operator for compiling sent ACK messages and generating second sum IVs for use by the decryption operator.

20. The encryption and decryption device of claim 19 wherein the protocol encryption algorithm operator is selected from a group consisting of: a WEP encryption algorithm operator, a WPA encryption algorithm operator, and a WPA2 encryption algorithm operator.
